(19) United States
(12) Patent Application Publication
(10) Pub. No.: US 2008/0203900 A1
(43) Pub. Date: Aug. 28, 2008

(54) LED White Source with Improved Color Rendering

(76) Inventors: Farn Hin Chen, Ipoh (MY); Kean Loo Keh, Penang (MY)

Correspondence Address: Kathy Manke;Avago Technologies Limited, 4380 Ziegler Road, Fort Collins, CO, 80525, US

(21) Appl. No.: 11/679,465

(22) Filed: Feb. 27, 2007

(51) Int. Cl. H05B 33/00

(52) U.S. Cl. 313/503; 313/506

(57) ABSTRACT

A light source that generates light having an output optical spectrum is disclosed. The light source includes first and second LEDs and a layer of phosphor that is excited by light from the first LED. The layer of phosphor is positioned to convert a portion of the light from the first LED in a first LED optical spectrum to light having a phosphor spectrum. The second LED emits light in a second LED optical spectrum. The first and second LEDs are powered such that the output optical spectrum includes the first and second optical spectrums and the phosphor spectrum such that the output spectrum is more constant as a function of wavelength at wavelengths between 450 nm to 650 nm than the first or second optical spectrums or the phosphor spectrum. The invention can provide a white LED light source with improved color rendering.

### BACKGROUND OF THE INVENTION

Color sensors are used in a number of applications to provide a measurement of the color of an object. For example, in interior decorating applications, such sensors are used to provide data on the color of a paint sample or fabric as that color would be perceived by a human observer. One class of color sensor utilizes a light source having a known output spectrum to illuminate the object and a plurality of photodetectors that measure the intensity of the light reflected by the object. Each photodetector measures the intensity of light in a corresponding band of wavelengths. A controller processes the output of the photodetectors to provide a determination of the color that a human observer would observe when viewing the object. For example, the intensities of tight in the red, blue, and green region of the spectrum that would reproduce the color of the object can be provided as the output. The light sources used in inexpensive color sensors are typically incandescent lights that emit white light.

Light emitting diodes (LEDs) are attractive candidates for replacing conventional light sources such as incandescent lamps and fluorescent light sources. The LEDs have higher light conversion efficiencies and longer lifetimes than the conventional sources. Unfortunately, LEDs produce light in a relatively narrow spectral band. Hence, to produce a light source having an arbitrary color, a compound light source having multiple LEDs or a single LED with a layer of phosphor that converts part of the LED light to light having a different spectrum must be utilized.

To replace conventional incandescent or fluorescent lighting systems, LED-based sources that generate light that appears to be “white” to a human observer are required. A light source that appears to be white can be constructed from a blue LED that is covered with a layer of phosphor that converts a portion of the blue light to yellow light, If the ratio of blue to yellow light is chosen correctly, the resultant light source appears white when viewed by a human observer.

However, when such a light source is used to illuminate a scene that is then viewed by a human observer, the observer perceives a scene that is markedly different from the scene that would be observed using an incandescent light or sunlight as the light source. In particular, the colors of the objects in the scene appear to be different than those seen with the incandescent light or sunlight. To reproduce the colors observed in a scene that is illuminated with the light source in a manner that matches the colors observed when the scene is illuminated with an incandescent light or sun light, the “white” light source must have a spectrum that is more or less constant over the visual wavelengths between about 400 nm and about 600 nm. The spectrum produced by a typical phosphor converted light source lacks intensity in the green and red portions of the optical spectrum. Hence, such white light sources perform poorly in color sensors.

In principle, a different phosphor composition could be utilized to improve the color rendering capability of the phosphor converted light source discussed above. However, a lamp designer does not have an arbitrary set of phosphors from which to choose. There are a limited number of conventional phosphors that have sufficient light conversion efficiencies. The emission spectrum of these phosphors is not easily changed. Furthermore, the spectra are less than ideal in that the light emitted as a function of wavelength is not constant. Hence, even by combining several phosphors, an optimum white light source is not obtained.

In addition, light conversion efficiency is an important factor in light source design. For the purposes of this discussion, the light conversion efficiency of a light source is defined to be the amount of light generated per watt of electricity consumed by the light source. The presently available phosphor converted light sources have achieved light conversion efficiencies that are better than those of fluorescent lamps that generate white light. The light conversion efficiency depends on the particular phosphor as well as the conversion efficiency of the LED that illuminates the phosphor. Hence, the designer faces further limitations in choosing a different phosphor composition.

### SUMMARY OF THE INVENTION

The present invention includes a light source that generates light having an output optical spectrum, the light source includes first and second LEDs and a layer of phosphor. The first LED emits light at a wavelength that excites a phosphor that emits light having a first LED optical spectrum. The layer of phosphor is positioned to convert a portion of the light emitted by the first LED to light having a phosphor spectrum. The second LED emits light in a second LED optical spectrum. The first and second LEDs are powered such that the output optical spectrum includes the first and second optical spectrums and the phosphor spectrum such that the output spectrum is more constant as a function of wavelength at wavelengths between 450 nm to 650 nm than the first or second optical spectrums or the phosphor spectrum. In one aspect of the invention, the first LED emits light at wavelengths between 400 nm to 500 nm, and the phosphor converts a portion of that light to light at wavelengths between 500 nm to 650 nm. The second optical spectrum includes a band of wavelengths between 580 nm-680 nm and/or wavelengths between 480 nm to 500 nm.

### BRIEF DESCRIPTION OF THE DRAWINGS

FIG. 1 illustrates the spectrum of the light that is generated by a typical phosphor-converted white light source.

FIG. 2 illustrates the combined spectrum that is obtained when a blue-green LED having a center wavelength of approximately 500 nm is added to the white light source whose spectrum is shown in FIG. 1.

FIG. 3 illustrates the spectrum that is obtained by adding three LEDs to the white light source shown in FIG. 1.

FIG. 4 is a cross-sectional view of a typical prior art phosphor converted white light source.

FIG. 5 is a cross-sectional view of a light source according to one embodiment of the present invention.

FIG. 6 is a cross-sectional view of another embodiment of a light source according to the present invention.

FIG. 7 illustrates a color sensor according to one embodiment of the present invention

### DETAILED DESCRIPTION OF THE PREFERRED EMBODIMENTS OF THE INVENTION

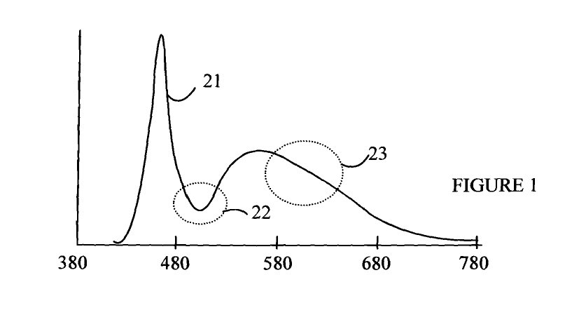

Refer now to FIG. 1, which illustrates the spectrum of the light that is generated by a typical phosphor-converted white light source. The spectrum generated by the white light source is shown at 21. As can be seen from the figure, the spectrum is deficient in the regions corresponding to green and red light that are shown at 22 and 23, respectively. The present invention is based on the observation that the spectrum deficiencies in terms of the power that would need to be added at the wavelengths in question is relatively small compared to the overall power output of the device. Hence, by combining one or more LEDs having emission spectrums in the regions of deficiency with the phosphor-converted light source, a light source having improved color rendering can be obtained without substantially altering the light conversion efficiency of the final light source. Furthermore, since the white phosphor-converted light source is not altered, the economies of scale inherent in the phosphor-converted light source production facilities can be maintained with respect to that component of the final light source.

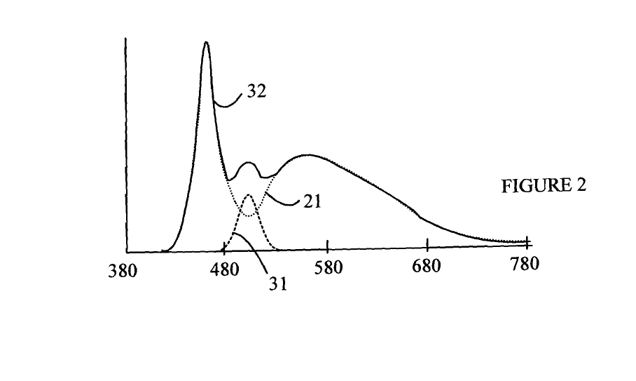

The additional LEDs preferably emit light in the blue-green region of the spectrum, i.e., 480 nm to 500 nm, and in the amber-red region of the spectrum, i.e., 580 to 680 nm. Refer now to FIG. 2, which illustrates the combined spectrum that is obtained when a blue-green LED having a center wavelength of approximately 500 nm is added to the white light source whose spectrum is shown in FIG. 1. The spectrum of the blue-green LED is shown at 31. The compound spectrum shown at 32 is substantially more constant in intensity as a function of wavelength than that of the white LED alone. The power in the additional LED is a small fraction of the power in the blue LED used to implement the white LED. Hence, the effect of using an additional LED that has a reduced light conversion efficiency relative to the blue LED is minimal. However, the color rendering ability of the compound LED is significantly better than that of the white LED by itself.

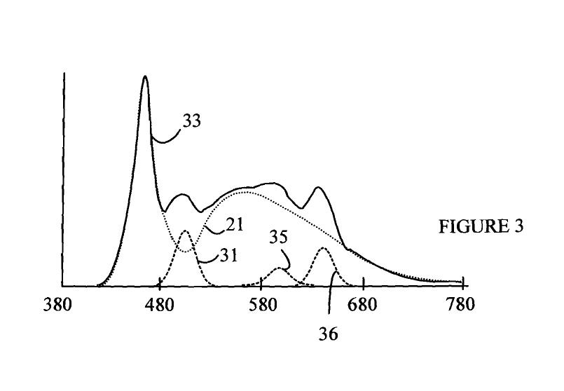

Additional benefits in terms of color rendering can be obtained by including additional LEDs in the light source. Refer now to FIG. 3, which illustrates the spectrum that is obtained by adding three LEDs to the white light source shown in FIG. 1. The spectra of the three LEDs are shown at 31, 35, and 36. The compound spectrum is shown at 33. As can be seen from the figure, the compound spectrum is substantially more constant in intensity as a function of wavelength over the region from about 450 nm to 650 nm than the spectrum generated by the white LED.

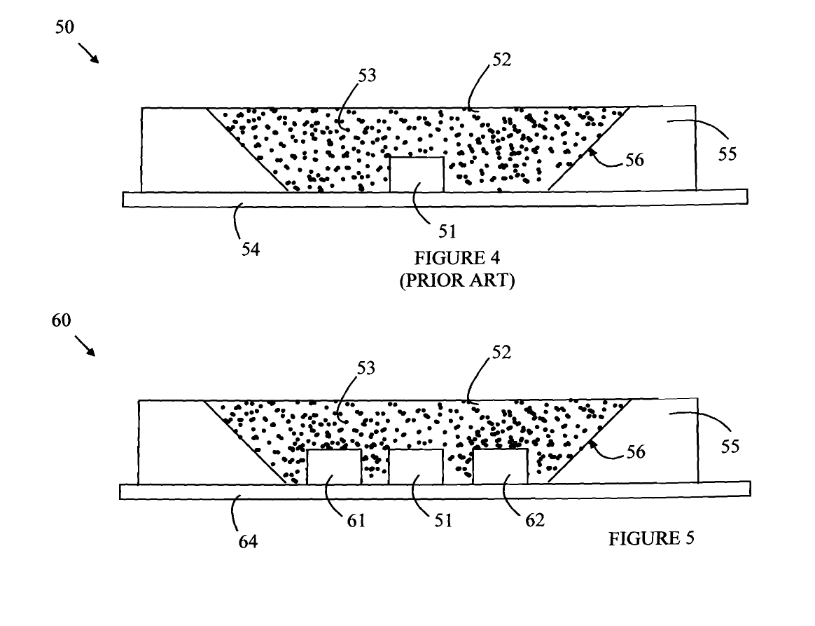

In the following discussion, the additional LEDs used to improve the color rendering of the compound light source will be referred to as the color rendering LEDs. The physical placement of the color rendering LEDs relative to the blue LED used in the white light source can affect the perceived color of the light source. Refer now to FIG. 4, which is a cross-sectional view of a typical prior art phosphor converted white light source. Light source 50 includes a die 51 having a blue LED thereon. The die is connected to conductors in a substrate 54. The specific connection scheme utilized to connect the die is of no importance to the present discussion. It is sufficient to note that the die has two contacts that are connected to the conductors and that the substrate includes electrodes for connecting the conductors to external circuitry.

An encapsulating layer 52 that includes particles of the phosphor 53 used to convert a portion of the blue light to yellow light is placed over die 51. The yellow light generated by the phosphor particles appears to originate from an extended light source that has the dimensions of the encapsulating layer since each phosphor particle acts as a separate light source that emits light in all directions. The blue light that is not converted by the phosphor particles is scattered by the phosphor particles and/or scattering particles that are included in the encapsulant layer. Hence, the blue light source also appears to have the dimensions of the encapsulating layer.

The die is often placed in a cup 55 that has reflective sides 56. The cup redirects the light leaving the particles in a sideways direction to the forward direction to improve the light collection efficiency. In the embodiment shown in FIG. 5, the cup also acts as a mold for the encapsulation layer. The cup also defines the size and shape of the light source.

In one embodiment of the present invention, the color rendering LEDs are also enclosed in the same encapsulating layer. This assures that the light from the color rendering LEDs appears to originate from the same physical light source as the white light. Refer now to FIG. 5, which is a cross-sectional view of a light source according to one embodiment of the present invention. Light source 60 utilizes 3 dies. A blue-emitting die 51 that excites phosphor particles 53 and two color rendering dies shown at 61 and 62. Color rendering die 61 includes an LED that emits light in the 580 to 680 nm region of the optical spectrum, and color rendering die 62 emits light in the 480 nm to 550 nm region of the optical spectrum. The individual dies are connected to conducting traces in substrate 64 and are powered by external circuitry that is connected to those traces. The relative intensities of the light from the three dies is set to provide a more constant intensity of light as a function of wavelength in the optical band from 450 nm to 680 nm than is provided by the blue LED alone.

In general, the long wavelength LEDs used to improve color rendering do not provide a significant amount of light at wavelengths that excite the phosphor particles. However, the phosphor particles scatter the light, and hence, the light source appears to be a single white source having a shape determined by the encapsulating layer. If the color rendering LEDs excite the phosphor to some degree, the amount of phosphor can be reduced to account for the additional yellow light generated by the color rendering LEDs and/or the intensity of light from the blue LED.

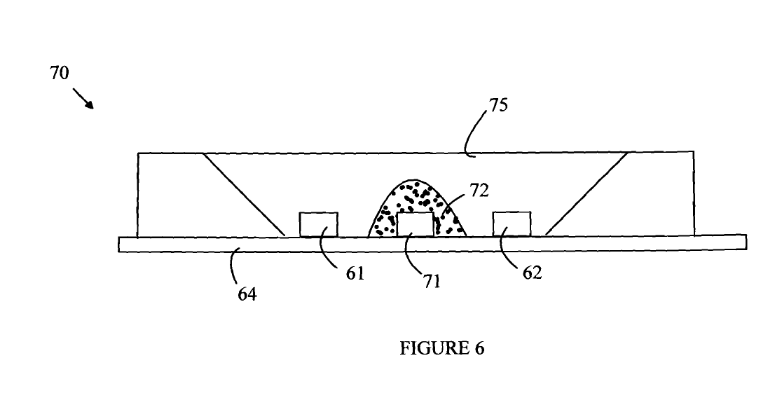

Alternatively, the color rendering LEDs can be placed outside the encapsulating layer that includes the phosphor particles. Refer now to FIG. 6, which is a cross-sectional view of another embodiment of a light source according to the present invention. Light source 70 utilizes a phosphor converted LED on die 71 and color rendering LEDs on dies 61 and 62. The phosphor layer used to convert the light from LED 71 is confined to a first layer of encapsulant shown at 72. A second layer of encapsulant 75 that lacks the phosphor particles covers both the phosphor layer and dies containing the color rendering LEDs. Encapsulant layer 75 can also include scattering particles so that the light leaving light source 70 appears to originate in a light source having the physical dimensions of encapsulant layer 75.

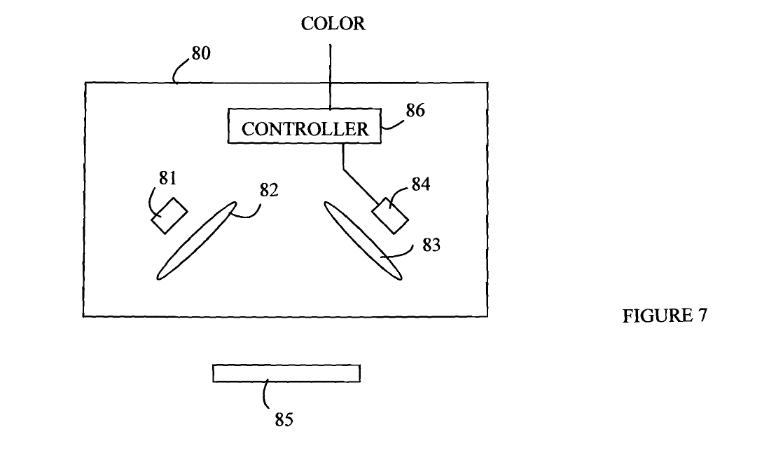

Embodiments of a light source according to the present invention can be utilized to construct a color sensor of the type discussed above. Refer now to FIG. 7, which illustrates a color sensor 80 according to one embodiment of the present invention. Color sensor 80 includes a light source 81 according to the present invention that operates in a manner analogous to that described above. Light from light source 81 is collimated by a lens 82 such that the light illuminates an object 85 having a color that is to be measured. A lens 83 images light from object 85 onto a photodetector 84 that generates a plurality of signals, each signal representing the intensity of light in a predetermined band of wavelengths. A controller 86 processes the signals from photodetector 84 to generate a color measurement that is output to the user or another device that uses the color measurement. Photodetector 84 can be constructed from an array of photodiodes in which each photodiode is covered by a bandpass filter that limits the response of that photodiode to the desired spectral band that is to be measured by that photodiode.

Various modifications to the present invention will become apparent to those skilled in the art from the foregoing description and accompanying drawings. Accordingly, the present invention is to be limited solely by the scope of the following claims.

What is claimed is:

1. A light source that generates light having an output optical spectrum, said light source comprising:
a first LED that emits light having a first LED optical spectrum that excites a phosphor with a first efficiency, said phosphor emitting light in a phosphor optical spectrum;
a layer of said phosphor positioned to convert a portion of said light emitted by said first LED optical spectrum to light in said phosphor spectrum;
a second LED that emits light having a second LED optical spectrum, said second LED exciting said phosphor with a second efficiency that is less than said first efficiency;
said first and second LEDs being powered such that said output optical spectrum comprises said first, and second LED optical spectrums and said phosphor optical spectrum and such that said output spectrum is more constant in intensity as a function of wavelength over wavelengths between 450 nm and 650 nm than a spectrum comprising said first LED optical spectrum and said phosphor spectrum, but not said second LED optical spectrum.

2. The light source of claim 1 further comprising a third LED that emits light in a third LED optical spectrum, said third optical spectrum exciting said phosphor with a third efficiency that is less than said first efficiency, said third LED being powered such that said output optical spectrum comprises said first, second, and third LED optical spectrums and said phosphor optical spectrum and such that said output optical spectrum is more constant in intensity as a function of wavelength over wavelengths between 450 mn and 650 nm than a spectrum comprising said first and second LED optical spectrums and said phosphor spectrum, but not said third LED optical spectrum.

3. The light source of claim 2 wherein said first LED emits light at wavelengths between 400 nm and 500 mn and wherein said phosphor converts a portion of that light to light at wavelengths between 500 nm and 650 nm.

4. The light source of claim 3 wherein said second LED optical spectrum comprises a band of wavelengths between 480 and 500 nm.

5. The light source of claim 3 wherein said third LED optical spectrum comprises a band of wavelengths between 580 nm and 680 nm.

6. The light source of claim 2 wherein said first, second and third LEDs are encapsulated in a layer of material containing said phosphor.

7. The light source of claim 2 wherein said first LED is encapsulated in a first layer of material that includes said phosphor, said second and third LEDs being outside of said encapsulating layer, and wherein said first, second and third LEDs are covered by a second layer of encapsulating material that does not include said phosphor.

8. The light source of claim 7 wherein said second layer of encapsulating material includes a diffusant that scatters light having wavelengths in said output optical spectrum.

9. The light source of claim 1 further comprising an optical system for illuminating an object external to said light source with light from said first and second LEDs; and
a photodetector positioned to receive part of said light that is reflected from said object, said photodetector generating a plurality of signals, each signal being indicative of an intensity of said received light in a corresponding band of wavelengths.

10. The light source of claim 9 further comprising a controller that operates on said plurality of signals to provide an output indicative of a color of light that a human observer would perceive originates from said object.
